(19) United States
(12) Patent Application Publication
(10) Pub. No.: US 2025/0298602 A1
(43) Pub. Date: Sep. 25, 2025

(54) METHODS FOR OPERATING HOUSEHOLD APPLIANCES

(71) Applicant: Haier US Appliance Solutions, Inc., Wilmington, DE (US)

(72) Inventor: Jason Fuchs, Louisville, KY (US)

(21) Appl. No.: 18/613,818

(22) Filed: Mar. 22, 2024

(51) Int. Cl. G06F 8/65

(52) U.S. Cl. CPC G06F 8/65

(57) ABSTRACT

A method of using a remote server to operate a household appliance includes communicating to a household appliance in operative communication with the remote server through a network that an update is available for the appliance, starting a timer with a predetermined time range for the available update to be applied, receiving data indicative of an availability of a user of the appliance, determining the availability of the user based on the received data, determining an optimal update time within the predetermined time range of the timer based on the determined availability of the user, and providing a notification of the available update for the appliance at the determined optimal update time.

### FIELD OF THE INVENTION

The present subject matter relates generally to household appliances, more particularly to methods for operating household appliances.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances.

Some household appliances can also include features for connecting to and communicating over a secure wireless network. Such communication may provide connected features on the household appliances, e.g., where the household appliance communicates with a personal device, smart home systems, and/or a remote server/computing device such as a cloud server or database. Such communication may also provide the ability to update the household appliances, such as to provide new or improved features and functionality to the household appliances by downloading updated control software or firmware to the connected household appliance from the cloud.

Such updates are not necessarily actually provided or applied to the household appliance when available. For example, some users may find the update process for such household appliances to be burdensome or inconvenient, such as when the user is notified of the update and asked to apply it at a time when the user is not in a position to easily access or pay attention to the household appliance.

Accordingly, improved methods for operating household appliances would be useful. In particular, a method for operating a household appliance such that notifications are provided to a user of the household appliance when the user is available would be particularly beneficial.

### BRIEF DESCRIPTION OF THE INVENTION

Aspects and advantages of the invention will be set forth in part in the following description, may be apparent from the description, or may be learned through practice of the invention.

In one exemplary embodiment, a method of using a remote server to operate a household appliance is provided. The remote server is in operative communication with the household appliance and a remote user device through a network. The method includes communicating, to the household appliance, that an update is available for the household appliance, starting a timer with a predetermined time range for the available update to be applied, receiving, from the remote user device or the household appliance, data indicative of an availability of a user of the household appliance, determining the availability of the user based on the received data from the remote user device or the household appliance, determining an optimal update time within the predetermined time range of the timer based on the determined availability of the user, and providing, to the household appliance or the remote user device, a notification of the available update for the household appliance at the determined optimal update time.

In another exemplary embodiment, a method of using a remote user device to operate a household appliance is provided. The remote user device is in operative communication with the household appliance and a remote server through a network. The method includes receiving, from the remote server, a communication that an update is available for the household appliance, sending, to the remote server, data indicative of an availability of a user of the household appliance, and receiving, from the remote server, a notification of an update that is available for the household appliance at a determined optimal update time based on the data indicative of the availability of the user sent by the remote user device.

In yet another exemplary embodiment, a method of using a control panel of a household appliance to operate the household appliance is provided. The household appliance is in operative communication with a remote user device and a remote server through a network. The method includes receiving, from the remote server, a communication that an update is available for the household appliance, and receiving, from the remote server, a notification of the available update at a determined optimal update time based on a determined availability of a user of the household appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a plurality of household appliances connected to a remote server through an external network according to an example embodiment of the present subject matter.

FIG. 2 provides a side cross-sectional view of an exemplary laundry appliance of the plurality of household appliances of FIG. 1.

FIG. 3 illustrates a system diagram and communication steps for operating a household appliance such that update notifications are provided to the user of the household appliance according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

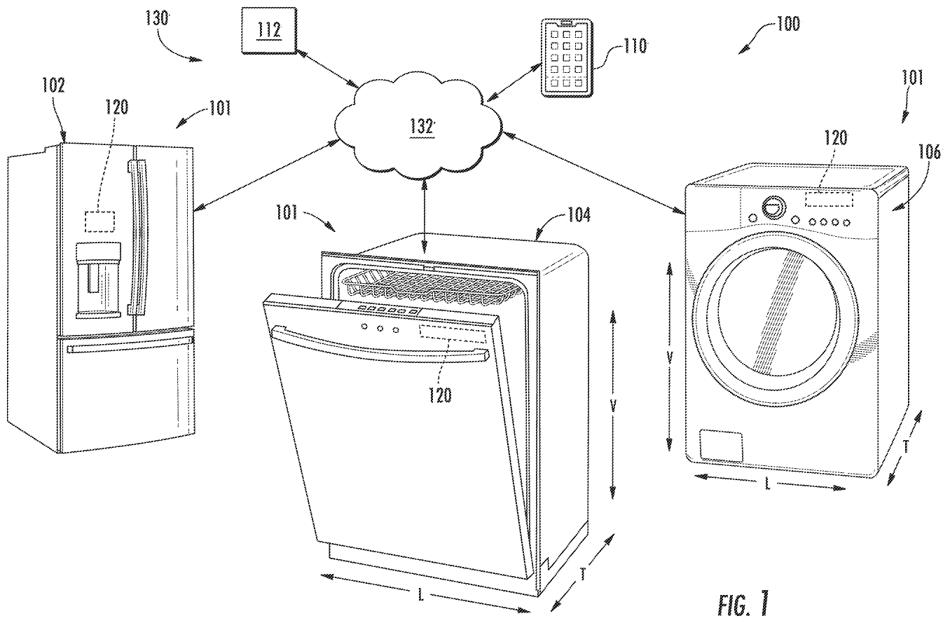

Referring now to FIG. 1, a system of household appliances 100 will be described according to exemplary embodiments of the present subject matter. In general, the system of appliances 100 may include any suitable number, type, and configuration of appliances, remote servers, network devices, and/or other external devices. Some of these appliances 100 may be able to communicate with each other or are otherwise interconnected. This interconnection, interlinking, and interoperability of multiple appliances and/or devices may commonly be referred to as “smart home” or “connected home” appliance interconnectivity.

FIG. 1 illustrates the system of appliances 100 according to exemplary embodiments of the present subject matter. As shown, the system of appliances 100 generally includes one or more household appliances 101, such as a first appliance 102 (e.g., illustrated herein as a refrigerator appliance), a second appliance 104 (e.g., illustrated herein as a dishwasher), and a third appliance 106 (e.g., illustrated herein as a washing machine). Details regarding the operation of first appliance 102, second appliance 104, and third appliance 106 may be understood by one having ordinary skill in the art and detailed discussion is omitted herein for brevity. However, it should be appreciated that the specific appliance types and configurations are only exemplary and are provided to facilitate discussion regarding the use and operation of the exemplary system of appliances 100. The scope of the present subject matter is not limited to the number, type, and configurations of appliances set forth herein.

For example, the system of appliances 100 may include any suitable number and type of “appliances,” such as “household appliances.” These terms are used herein to describe appliances typically used or intended for common domestic tasks, e.g., such as the appliances as illustrated in the figures. According to still other embodiments, these “appliances” may include but are not limited to a refrigerator, a dishwasher, a microwave oven, a cooktop, an oven, a washing machine, a dryer, a water heater, a water filter or purifier, an air conditioner, a space heater, and any other household appliance which performs similar functions. Moreover, although only three appliances are illustrated, various embodiments of the present subject matter may also include another number of appliances, each of which may generate and store data.

In addition, it should be appreciated that system of appliances 100 may include one or more external devices, e.g., devices that are separate from or external to the one or more appliances, and which may be configured for facilitating communications with various appliances or other devices. For example, according to exemplary embodiments of the present subject matter, the system of appliances 100 may include or be communicatively coupled with a remote user device 110 that may be configured to enable user interaction with some or all appliances or other devices in the system of appliances 100.

In general, remote user device 110 may be any suitable device separate and apart from appliances (e.g., such as first appliance 102, second appliance 104, and third appliance 106) that is configured to provide and/or receive communications, information, data, or commands from a user. In this regard, remote user device 110 may be an additional user interface to the user interface panels of the various appliances within the system of appliances 100. In this regard, for example, the user device 110 may be a personal phone, a smartphone, a tablet, a laptop or personal computer, a wearable device, a smart home system, or another mobile or remote device. For example, the separate device may be a smartphone operable to store and run applications, also known as “apps,” and the remote user device 110 be provided as a smartphone app.

In addition, as will be described in more detail below, some or all of the system of appliances 100 may include or be communicatively coupled with a remote server 112 that may be in operative communication with remote user device 110 and/or some or all appliances within system of appliances 100. Thus, user device 110 and/or remote server 112 may refer to one or more devices that are not considered household appliances as used herein. In addition, devices such as a personal computer, router, network devices, and other similar devices whose primary functions are network communication and/or data processing are not considered household appliances as used herein.

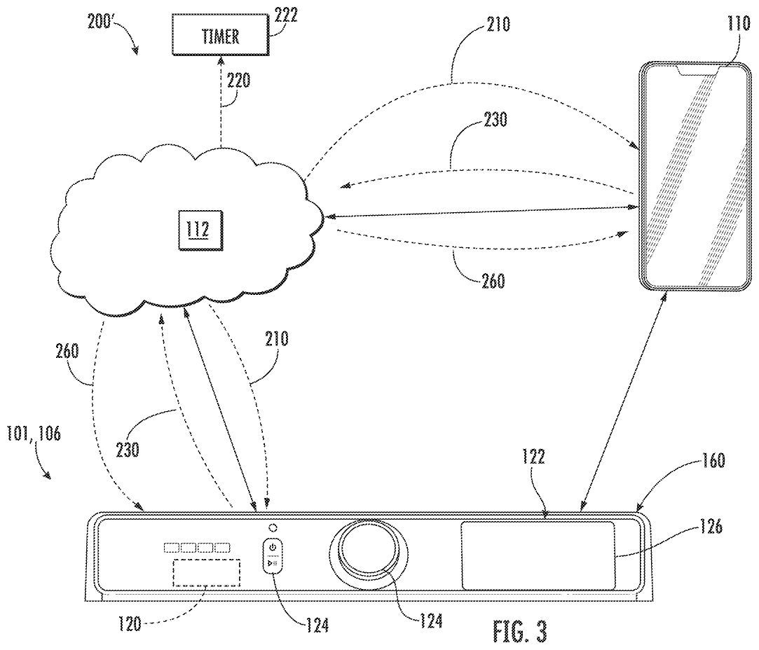

Referring to FIG. 3, one or more of the household appliances 101, such as the third appliance 106, may include a control panel 122 that may represent a general-purpose Input/Output (“GPIO”) device or functional block for the corresponding household appliance 101. In some embodiments, control panel 122 may include or be in operative communication with one or more user interfaces 124, such as one or more of a variety of digital, analog, electrical, mechanical, or electro-mechanical input devices including rotary dials, control knobs, push buttons, toggle switches, selector switches, and touch pads. Additionally, the household appliances 101 may each include a displa 30, such as a digital or analog display device generally configured to provide visual feedback regarding the operation of the corresponding household appliance 101. For example, display 126 may be provided on control panel 122 and may include one or more status lights, screens, or visible indicators. According to exemplary embodiments, user input devices 124 and display 126 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Referring to FIGS. 1 and 3, each of the household appliances 101, remote user device 110, or any other devices or appliances in system of appliances 100 may include or be operably coupled to a controller, identified herein generally by reference numeral 120, that may be generally configured to facilitate appliance operation. In this regard, control panel 122, user interfaces 124, and display 126 may be in communication with controller 120 such that controller 120 may receive control inputs from user interfaces 124, may display information using display 126, and may otherwise regulate operation of the household appliances 101. For example, signals generated by controller 120 may operate the household appliances 101, including any or all system components, subsystems, or interconnected devices, in response to the position of user interfaces 124 and other control commands. Control panel 122 and other components of the household appliances 101 may be in communication with controller 120 via, for example, one or more signal lines or shared communication busses. In this manner, Input/Output (“I/O”) signals may be routed between controller 120 and various operational components of the household appliances 101.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to controller 120 through any suitable communication module, communication lines, or network(s).

Referring to FIG. 1, a schematic diagram of an external communication system 130 will be described according to an exemplary embodiment of the present subject matter. In general, external communication system 130 is configured for permitting interaction, data transfer, and other communications between and among first appliance 102, second appliance 104, third appliance 106, remote user device 110, remote server 112, other appliances within system of appliances 100, and/or one or more external devices. For example, this communication may be used to provide and receive operating parameters, cycle settings, user instructions or notifications, performance characteristics, user preferences, or any other suitable information for improved performance of one or more appliances within system of appliances 100. In addition, it should be appreciated that external communication system 130 may be used to transfer data or other information to improve performance of one or more external devices or appliances and/or improve user interaction with such devices.

In addition, remote server 112 may be in communication with an appliance and/or remote user device 110 through a network 132. In this regard, for example, remote server 112 may be a cloud-based server 112, and is thus located at a distant location, such as in a separate state, country, etc. According to an exemplary embodiment, remote user device 110 may communicate with a remote server 112 over network 132, such as the Internet, to transmit/receive data or information, provide user inputs, receive user notifications or instructions, interact with or control the appliance, etc. In addition, remote user device 110 and remote server 112 may communicate with the appliance to communicate similar information.

In general, communication between an appliance, remote user device 110, remote server 112, and/or other user devices or appliances may be carried using any type of wired or wireless connection and using any suitable type of communication network, non-limiting examples of which are provided below. For example, remote user device 110 may be in direct or indirect communication with the appliance through any suitable wired or wireless communication connections or interfaces, such as network 132. For example, network 132 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 130 is described herein according to an exemplary embodiment of the present subject matter. However, it should be appreciated that the exemplary functions and configurations of external communication system 130 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

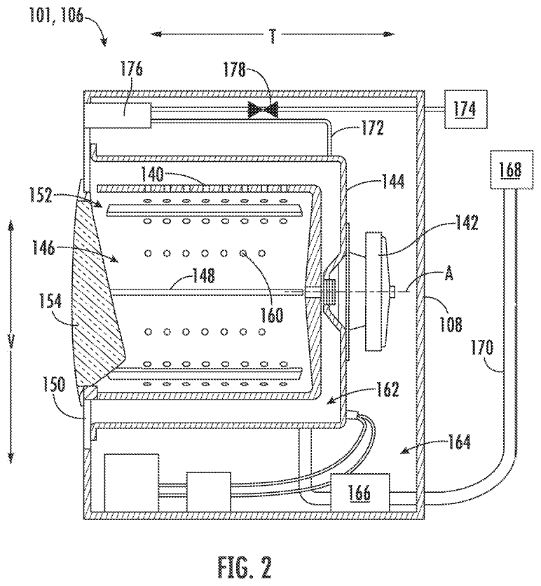

Referring to FIG. 2, a side cross-sectional view of an exemplary laundry appliance of the system of appliances 100 of FIG. 1 is illustrated. In particular, FIG. 2 illustrates the third appliance or washing machine appliance 106. As shown in FIG. 2, a wash basket 140 is rotatably mounted within a cabinet 108 of the washing machine appliance 106 such that it is rotatable about an axis of rotation A. A motor 142, e.g., such as a pancake motor, is in mechanical communication with wash basket 140 to selectively rotate wash basket 140 (e.g., during an agitation or a rinse cycle of washing machine appliance 106). Wash basket 140 is received within a wash tub 144 and defines a laundry or wash chamber 146 that is configured for receipt of articles for laundering (e.g., washing). The wash tub 144 holds wash and rinse fluids for agitation in wash basket 140 within wash tub 144. As used herein, “wash fluid” may refer to water, detergent, fabric softener, bleach, or any other suitable wash additive or combination thereof. Indeed, for simplicity of discussion, these terms may all be used interchangeably herein without limiting the present disclosure to any particular “wash fluid.”

Wash basket 140 may define one or more agitator features that extend into wash chamber 146 to assist in agitation and cleaning articles disposed within wash chamber 146 during operation of washing machine appliance 106. For example, as illustrated in FIG. 2, a plurality of ribs 148 extends from basket 140 into wash chamber 146. In this manner, for example, ribs 148 may lift articles disposed in wash basket 140 during rotation of wash basket 140.

Cabinet 108 also includes a front panel 150 which defines an opening 152 that permits user access to wash basket 140 of wash tub 144. More specifically, washing machine appliance 106 includes a door 154 that is positioned over opening 152 and is rotatably mounted to front panel 150. In this manner, door 154 permits selective access to opening 152 by being movable between an open position (not shown) facilitating access to a wash tub 144 and a closed position (FIG. 2) prohibiting access to wash tub 144.

A window (not shown) in door 154 permits viewing of wash basket 140 when door 154 is in the closed position, e.g., during operation of washing machine appliance 106. Door 154 also includes a handle (not shown) that, e.g., a user may pull when opening and closing door 154. Further, although door 154 is illustrated as mounted to front panel 150, it should be appreciated that door 154 may be mounted to another side of cabinet 108 or any other suitable support according to alternative embodiments. Washing machine appliance 106 may further include a latch assembly (not shown) that is mounted to cabinet 108 or door 154 for selectively locking door 154 in the closed position or confirming that the door is in the closed position. The latch assembly (not shown) may be desirable, for example, to ensure only secured access to wash chamber 146 or to otherwise ensure and verify that door 154 is closed during certain operating cycles or events.

Wash basket 140 also defines a plurality of perforations 160 in order to facilitate fluid communication between an interior of basket 140 and wash tub 144. A sump 162 is defined by wash tub 144 at a bottom of wash tub 144 along the vertical direction V. Thus, sump 162 is configured for receipt of and generally collects wash fluid during operation of washing machine appliance 106. For example, during operation of washing machine appliance 106, wash fluid may be urged by gravity from basket 140 to sump 162 through plurality of perforations 160.

A drain pump assembly 164 is located beneath wash tub 144 and is in fluid communication with sump 162 for periodically discharging soiled wash fluid from washing machine appliance 106. Drain pump assembly 164 may generally include a drain pump 166 which is in fluid communication with sump 162 and with an external drain 168 through a drain hose 170. During a drain cycle, drain pump 166 urges a flow of wash fluid from sump 162, through drain hose 170, and to external drain 168. More specifically, drain pump 166 includes a motor (not shown) which is energized during a drain cycle such that drain pump 166 draws wash fluid from sump 162 and urges it through drain hose 170 to external drain 168.

Washing machine appliance 106 may further include a wash fluid dispenser that is generally configured for dispensing a flow of water, wash fluid, etc. into wash tub 144. For example, a spout 172 is configured for directing a flow of fluid into wash tub 144. For example, spout 172 may be in fluid communication with a water supply 174 in order to direct fluid (e.g., clean water or wash fluid) into wash tub 144. Spout 172 may also be in fluid communication with the sump 162. For example, pump assembly 164 may direct wash fluid disposed in sump 162 to spout 172 in order to circulate wash fluid in wash tub 144.

As illustrated in FIG. 2, a detergent dispenser 176 is slidably mounted within front panel 150. Detergent dispenser 176 receives a wash additive (e.g., detergent, fabric softener, bleach, or any other suitable liquid or powder) and directs the fluid additive to wash tub 144 during operation of washing machine appliance 106. According to the illustrated embodiment, detergent dispenser 176 may also be fluidly coupled to spout 172 to facilitate the complete and accurate dispensing of wash additive. It should be appreciated that according to alternative embodiments, these wash additives could be dispensed automatically via a bulk dispensing unit (not shown). Other systems and methods for providing wash additives are possible and within the scope of the present disclosure.

In addition, a water supply valve 178 may provide a flow of water from a water supply source (such as a municipal water supply 174) into detergent dispenser 176 and into wash tub 144. In this manner, water supply valve 178 may generally be operable to supply water into detergent dispenser 176 to generate a wash fluid, e.g., for use in a wash cycle, or a flow of fresh water, e.g., for a rinse cycle. It should be appreciated that water supply valve 178 may be positioned at any other suitable location within cabinet 108. In addition, although water supply valve 178 is described herein as regulating the flow of “wash fluid,” it should be appreciated that this term includes, water, detergent, other additives, or some mixture thereof.

During operation of washing machine appliance 106, laundry items are loaded into wash basket 140 through opening 152, and washing operation is initiated through operator manipulation of one or more input selectors or using a remote device. Wash tub 144 is filled with water, detergent, or other fluid additives, e.g., via spout 172 or detergent dispenser 176. One or more valves (e.g., water supply valve 178) can be controlled by washing machine appliance 106 to provide for filling wash basket 140 to the appropriate level for the amount of articles being washed or rinsed. By way of example for a wash mode, once wash basket 140 is properly filled with fluid, the contents of wash basket 140 can be agitated (e.g., with ribs 148) for washing of laundry items in wash basket 140.

After the agitation phase of the wash cycle is completed, wash tub 144 can be drained. Laundry articles can then be rinsed by again adding fluid to wash tub 144, depending on the particulars of the cleaning cycle selected by a user. Ribs 148 may again provide agitation within wash basket 140. One or more spin cycles may also be used. In particular, a spin cycle may be applied after the wash cycle or after the rinse cycle in order to wring wash fluid from the articles being washed. During a final spin cycle, basket 140 is rotated at relatively high speeds and drain assembly 164 may discharge wash fluid from sump 162. After articles disposed in wash basket 140 are cleaned, washed, or rinsed, the user can remove the articles from wash basket 140, e.g., by opening door 154 and reaching into wash basket 140 through opening 152.

Now that the construction of an exemplary household appliance (e.g., the washing machine appliance 106) of the system of household appliances 100 and the configuration of controller 120 according to exemplary embodiments have been presented, an exemplary method 200 of operating a household appliance will be described. In this regard, method 200 provides an example method for operating a household appliance to provide notifications of available updates for the household appliance(s) to a user of the appliance(s) at an optimal update time. Although the discussion below refers to the exemplary method 200 of operating washing machine appliance 106, one skilled in the art will appreciate that the exemplary method 200 is applicable to the operation of a variety of other household appliances, such as dishwasher appliances, refrigerator appliances, dryer appliances, etc. In exemplary embodiments, the various method steps as disclosed herein may be performed by controller 120, remote server 112, remote user device 110, etc.

Referring now to FIG. 3, method 200 includes, at step 210, communicating, to the household appliance 101 or the remote user device 110, that an update is available for the household appliance 101. The remote server 112 may have an established link with each appliance 102, 104, 106 of the system of household appliances 100 and the remote user device 110. As such, remote server 112 may communicate/transmit, and household appliance 101 and/or the remote user device 110 may receive, that an update is available for the household appliance 101. For example, the available update may be a software update for improving functionality of the household appliance 101.

Step 220 may include starting a timer with a predetermined time range for the available update to be applied. For example, after the remote server 112 has communicated to the household appliance 101 that the update is available for the household appliance 101, the remote server 112 may start a timer 222. The timer 222 may initiate upon the communication to the household appliance 101 that the update is available for the household appliance 101 and stop once the timer 222 has reached the end of a predetermined time range (e.g., one day, one month, etc.) for the available update to be applied to the household appliance 101. The predetermined time range may correspond to a maximum time range in which the available update is to be applied to the household appliance 101. As will be described below, the user of the household appliance 101 may accept/apply the available update to the household appliance 101 within the predetermined time range, or, if the user does not do so, the available update may be “forced” or automatically applied to the household appliance 101 no further prompts to the user.

Notably, the remote server 112 may interact with the remote user device 110 (e.g., such as a user's cell phone or smartwatch) and/or the household appliance 101 such that data may be transferred between the remote server 112 and the remote user device 110 and/or the household appliance 101. Such data may be indicative of an availability of the user of the household appliance 101. As such, step 230 includes receiving, from the remote user device 110 or the household appliance 101, data indicative of an availability of the user of the household appliance 101.

For example, the remote user device 110 may generate location data indicative of the location of the remote user device 110 (e.g., coordinates) and, thus, the user relative to the household appliance 101. Such data may indicate whether the user is at home or away from home. As such, when receiving the data indicative of the availability of the user, step 230 may include receiving location data from the remote user device 100 indicative of the location of the user relative to the household appliance 101.

Additionally, or alternatively, the remote user device 110 and/or the household appliance 101 may generate activity data indicative of an active status of the user. For example, the remote user device 100 may generate activity data indicative of the physical activity/inactivity of the user, such as whether the user is exercising. Likewise, the remote user device 100 and/or the household appliance 101 may generate activity data indicative of computing activity/inactivity of the user, such as whether the user is using an app, browsing the web, etc. As such, when receiving the data indicative of the availability of the user, step 230 may include receiving the activity data, such as the physical activity/inactivity data, computing activity/inactivity data, etc., from the remote user device 100 and/or the household appliance 110 indicative of the active status of the user.

Additionally, or alternatively, the remote user device 110 and/or the household appliance 101 may generate update data indicative of one or more times (e.g., time(s) of day, day(s) of week, etc.) when the user previously accepted notifications of available updates to update the household appliance 101. The time(s) when the user previously accepted notifications to update the household appliance 101 may indicate that the time(s) is a convenient time(s) for the user to accept a notification to update the household appliance 101. As such, when receiving the data indicative of the availability of the user, step 230 may include receiving the update data from the remote user device 100 and/or the household appliance 110 indicative of the time(s) when the user previously accepted notifications of available updates to update the household appliance 101.

Additionally, or alternatively, the remote user device 110 may access survey data from, for example, the Internet, indicative of one or more times when people are not busy and send the survey data to the remote server 112. For example, the survey data may be accessed from the American Time Use Survey (ATUS). Such survey data may quantify the amount of time people spend and the time(s) of day/day(s) of week that people spend performing various activities, such as paid work, childcare, volunteering, socializing, etc. and, thus, indicates when people are generally busy and not busy. As such, when receiving the data indicative of the availability of the user, step 230 may include receiving the survey data from the remote user device 100 indicative of the time(s) when people are not busy.

Additionally, or alternatively, the user may input data indicative of the availability of the user to the remote user device 110 and/or the household appliance 101. For example, the user may select one or more timeslots on the remote user device 110 (e.g., cell phone or smartwatch) and/or the control panel 122 of the household appliance 101 indicative of the time(s) day/day(s) of the week the user is most likely to be available to accept notifications of available updates to update the household appliance 101.

Step 240 may include determining the availability of the user based on the received data from the remote user device 110 or the household appliance 101. For example, the remote server 112 may determine the location of the user relative to the household appliance 101 based on the location data received from the remote user device 110. Additionally, or alternatively, the remote server 112 may determine the active status of the user, such as the user physical activity/inactivity, the user computing activity/inactivity, etc., based on the activity data received from the remote user device 110 and/or the household appliance 101. Additionally, or alternatively, the remote server 112 may determine the time(s) when the user previously accepted notifications of available updates to update the household appliance 101 based on the update data received from the remote user device 110 and/or the household appliance. Additionally, or alternatively, the remote server 112 may determine the time(s) when people are not busy based on the survey data received from the remote user device 110.

Thereafter, step 250 may include determining an optimal update time within the predetermined time range of the timer 222 based on the determined availability of the user. As will be described below, the remote server 112 may then provide a notification of the available update for the household appliance 101 at the determined optimal update time. Since the determined optimal update time is based on the determined availability of the user, such as whether the user may be at home, the chances of the user accepting the notification to update the household appliance are increased. The optimal update time may correspond to time(s) of day and/or day(s) of the week within the predetermined time range for providing notification(s) of the available update for the household appliance 101. For example, the remote server 112 may determine the optimal update time as a time when the determined location of the user relative to the household appliance 101 indicates that the user is at home, since the user may be more likely to accept notification(s) to update the household appliance 101 when at home than when away from home. Additionally, or alternatively, the remote server 112 may determine the optimal update time as a time when the determined active status of the user indicates that the user is inactive, since the user may be more likely to accept notification(s) to update the household appliance while not busy moving around and, thus, indicating that the user is busy doing other tasks. Additionally, or alternatively, the remote server 112 may determine the optimal update time as the determined time when the user previously accepted the notifications of the available updates to update the household appliance 101, which indicates an increased likelihood that the user will accept notifications at such times. Additionally, or alternatively, the remote server 112 may determine the optimal update time as the determined time when people are not busy based on the received survey data.

Step 260 may include providing, to the household appliance 101 or the remote user device 112, a notification of the available update for the household appliance 101 at the determined optimal update time. For example, the notification of the available update for the household appliance 101 may be provided on the display 126 of the control panel 122 of the household appliance 101. As such, one or more notifications may be sent at the optimal update time until the user accepts the notification to update the household appliance 101 or the timer 222 reaches the end of the time range for the available update to be applied, in which case the available updated may be applied “forcefully” or automatically without the need for the user to accept the notification(s). For example, the determined availability of the user may indicate that the optimal update time for providing notification(s) to the user with the highest likelihood that the user will accept the notification(s) is between 8 o'clock PM and 10 o'clock PM on Monday through Friday, because the user is home from work. In this respect, a notification may be sent to the user, via the remote user device 110 and/or the household appliance 101, between 8 o'clock PM and 10 o'clock PM every weeknight until the user accepts the notification(s) or the timer 222 reaches the end of the time range for the available update to be applied.

FIG. 3 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using washing machine appliance 100 as an example, it should be appreciated that these methods may be applied to the operation of any suitable washing machine appliance.

As explained above, aspects of the present subject matter are generally directed to a method of operating a household appliance such that notifications are provided to a user of the household appliance when the user is available. The method may allow a remote server to communicate to the household appliance, such as a washing machine appliance, that an update is available for the household appliance. After communicating the household appliance that the update is available, the remote server may start a timer that includes a predetermined time range, the end of which the available update may be automatically applied if the user has not accepted a notification(s) to update the household appliance. The remote server may receive data from a remote user device, such as a smartphone or smartwatch, and/or from the household appliance, indicative of the availability of the user. Thereafter, the remote server may determine an optimal update time for providing notifications to the user to update the household appliance. The optimal update time is within the predetermined time range of the timer and is determined based on the availability of the user.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of using a remote server to operate a household appliance, the remote server being in operative communication with the household appliance and a remote user device through a network, the method comprising:
communicating, to the household appliance or the remote user device, that an update is available for the household appliance;
starting a timer with a predetermined time range for the available update to be applied;
receiving, from the household appliance or the remote user device, data indicative of an availability of a user of the household appliance;
determining the availability of the user based on the received data from the household appliance or the remote user device;
determining an optimal update time within the predetermined time range of the timer based on the determined availability of the user; and
providing, to the household appliance or the remote user device, a notification of the available update for the household appliance at the determined optimal update time.

2. The method of claim 1, wherein:
receiving the data indicative of the availability of the user comprises:
receiving, from the remote user device, location data indicative of a location of the user relative to the household appliance; and
determining the availability of the user comprises:
determining the location of the user relative to the household appliance based on the received location data from the remote user device.

3. The method of claim 2, wherein determining the optimal update time based on the determined availability of the user comprises:
determining the optimal update time as a time when the determined location of the user relative to the household appliance indicates that the user is at home.

4. The method of claim 1, wherein:
receiving the data indicative of the availability of the user comprises:
receiving, from the remote user device or the household appliance, activity data indicative of an active status of the user; and
determining the availability of the user comprises:
determining the active status of the user based on the received activity data from the remote user device.

5. The method of claim 4, wherein determining the optimal update time based on the determined availability of the user comprises:
determining the optimal update time as a time when the determined active status of the user indicates that the user is inactive.

6. The method of claim 4, wherein the activity data indicative of the active status of the user comprises:
data indicative of a physical activity or a physical inactivity of the user.

7. The method of claim 4, wherein the activity data indicative of the active status of the user comprises:
data indicative of user computing activity or user computing inactivity on the remote user device or the household appliance.

8. The method of claim 1, wherein:
receiving the data indicative of the availability of the user comprises:
receiving, from the remote user device or the household appliance, update data indicative a time when the user previously accepted notifications of available updates to update the household appliance; and
determining the availability of the user comprises:
determining the time when the user previously accepted the notifications of available updates to update the household appliance based on the received update data from the remote user device or the household appliance.

9. The method of claim 8, wherein determining the optimal update time based on the determined availability of the user comprises:
determining the optimal update time as the determined time when the user previously accepted the notifications of the available updates to update the household appliance.

10. The method of claim 1, wherein:
receiving the data indicative of the availability of the user comprises:
receiving, from the remote user device, survey data indicative of a time when people are not busy; and
determining the availability of the user comprises:
determining the time when people are not busy based on the received survey data.

11. The method of claim 1, wherein:
the household appliance comprises a control panel; and
providing the notification of the available update for the household appliance at the determined optimal update time comprises:
providing, on the control panel of the household appliance, the notification of the available update for the household appliance.

12. A method of using a remote user device to operate a household appliance, the remote user device being in operative communication with the household appliance and a remote server through a network, the method comprising:
receiving, from the remote server, a communication that an update is available for the household appliance;
sending, to the remote server, data indicative of an availability of a user of the household appliance; and
receiving, from the remote server, a notification of an update that is available for the household appliance at a determined optimal update time based on the data indicative of the availability of the user sent by the remote user device.

13. The method of claim 12, wherein sending the data indicative of the availability of the user comprises:
sending, to the remote server, location data indicative of a location of the user relative to the household appliance.

14. The method of claim 12, wherein sending the data indicative of the availability of the user comprises:
sending, to the remote server, activity data indicative of an active status of the user.

15. The method of claim 14, wherein the activity data indicative of the active status of the user comprises:
data indicative of a physical activity or a physical inactivity of the user.

16. The method of claim 14, wherein the activity data indicative of the active status of the user comprises:
data indicative of user computing activity or user computing inactivity on the remote user device.

17. The method of claim 12, wherein sending the data indicative of the availability of the user comprises:
sending, to the remote server, update data indicative a time when the user previously accepted notifications of available updates to update the household appliance.

18. The method of claim 12, wherein sending the data indicative of the availability of the user comprises:
sending, to the remote server, survey data indicative of a time when people are not busy.

19. A method of using a control panel of a household appliance to operate the household appliance, the household appliance being in operative communication with a remote user device and a remote server through a network, the method comprising:
receiving, from the remote server, a communication that an update is available for the household appliance; and
receiving, from the remote server, a notification of the available update at a determined optimal update time based on a determined availability of a user of the household appliance.

20. The method of claim 19, wherein:
the determined availability of the user comprises:
a determined location of the user relative to the household appliance based on received location data from the remote user device; and
the determined the optimal update time comprises:
a time when the determined location of the user relative to the household appliance indicates that the user is at home.
